(19) United States
(12) Patent Application Publication
(10) Pub. No.: US 2025/0235915 A1
(43) Pub. Date: Jul. 24, 2025

(54) EXTRUSION SYSTEM AND METHOD OF SAME

(71) Applicants: Mohammad SHAKIBA, Brampton (CA); Pascal CHAREST, Brampton (CA)

(72) Inventors: Mohammad SHAKIBA, Brampton (CA); Pascal CHAREST, Brampton (CA)

(21) Appl. No.: 18/698,532

(22) PCT Filed: Oct. 3, 2022
(86) PCT No.: PCT/CA2022/051464

§ 371 Date: Apr. 4, 2024

(51) Int. Cl. B21C 23/04; B22F 3/20

(52) U.S. Cl. CPC B21C 23/04; B22F 3/20

(57) ABSTRACT

An extrusion system includes a container defining a channel extending along an axis for holding a feedstock. A ram is located on a first axial side of the channel and a die assembly is located on a second axial side of the channel opposite the first axial side. The ram is axially movable to push the feedstock into the die assembly. The die assembly defines at least one aperture extending through a part of the die assembly. A shearing surface is configured to shear and heat the material prior to entering the at least one aperture. At least part of the shearing surface or the container are configured to rotate about the axis while the at least one aperture remains rotationally stationary.

### CROSS-REFERENCE TO RELATED APPLICATION

This PCT International Patent Application claims the benefit of U.S. Provisional Patent Application Ser. No. 63/252,086 filed on Oct. 4, 2021 titled “Extrusion System and Method of Same,” the entire disclosures of which is hereby incorporated by reference.

### BACKGROUND OF THE INVENTION

### 1. Field of the Invention

The present invention relates to an extrusion system. More particularly, the present invention relates to an extrusion system including feedstock and/or shearing surface rotation mechanisms for extruding components, such as automotive components, and a method of the same.

### 2. Related Art

This section provides background information related to the present disclosure which is not necessarily prior art.

Automobiles are the subject of a continuing effort to reduce weight and increase fuel efficiency without detracting from performance. This desire to increase fuel efficiency is both economically and environmentally motivated and has led to a reduction in the weight of a variety of automotive components. These automotive components may be made from a variety of materials, including steel, aluminum, composites, alloys, etc., each of which have various benefits depending on end-use requirements. There are numerous methodologies that are utilized in the formation of automotive components. One of the more popular methods of forming automotive parts is via an extrusion process. In typical extrusion processes, metal (or another material) is forced to flow through a die assembly opening that provides a cross-section for a desired component shape. Extrusion processes are particularly popular in the automotive industry because components can be formed that meet tight tolerance requirements without much material waste and high production volumes. However, while exhibiting numerous benefits, extrusion processes are not without shortcomings. For example, extrusion processes typically require the use of primary alloys as feedstock, the feedstock and dies must be preheated prior to extruding the feedstock, and extrusion processes typically produce some engineering scrap.

Sheer assisted extrusion processes show a good potential to address the issues with conventional extrusion processes. In such processes, a die is rotated relative to the feedstock to heat up and shear the feedstock, but the rotational movement of the die relative to the feedstock also causes rotation of the final product as it is extruded, which can make it difficult to mass produce products within tight tolerances.

Accordingly, there is a continuing desire to further develop and refine extrusion systems and processes such that they are not subjected to existing drawbacks.

### SUMMARY OF THE INVENTION

It is an object of the present disclosure to provide shearing mechanisms for shear extrusion processes while avoiding rotation of final extruded products.

According to these and other aspects of the disclosure, an extrusion system includes a container defining a channel extending along an axis for holding a feedstock. A ram is located on a first axial side of the channel and a die assembly is located on a second axial side of the channel opposite the first axial side. The die assembly defines at least one aperture extending through a part of the die assembly. The ram is axially movable to push the feedstock into the die assembly to push the material through the at least one aperture. A shearing surface is configured to shear and heat the feedstock prior to entering the at least one aperture. At least part of the shearing surface or the container are configured to rotate about the axis while the at least one aperture remains rotationally stationary.

According to the above and other aspects of the disclosure, a method for extruding materials includes providing a container that defines a channel extending along an axis for holding a feedstock to be extruded. The method also includes providing a die assembly in axial alignment with the channel of the container. The die assembly defines at least one aperture extending through part of the die assembly. The method also includes pushing the feedstock against the die assembly to push material of the feedstock through the at least one aperture. The method also includes providing a shearing surface for shearing and heating the material prior to entering the at least one aperture. The method also includes rotating at least part of the shearing surface or the container containing the feedstock about the axis with the at least one aperture remaining rotationally stationary.

Accordingly, the subject apparatus and associated method allow the material of the feedstock to remain rotationally stationary while being pushed through the aperture after having been sheared and heated via rotation of the shearing surface or feedstock (via the container). Shearing and heating the material prior to entering the aperture effectively softens the material for extrusion. The rotationally stationary arrangement of the aperture provides a uniform flow of the material through the aperture, and toward an extrusion opening. This allows products of various shapes to repeatably be extruded through the extrusion opening without rotation of the final extruded products. This also allows different feedstock materials such as casting billets or chip briquettes of various alloys to be extruded.

According to another aspect of the present disclosure, at least part of the container is configured to rotate with the feedstock while the shearing surface and die assembly remain rotationally fixed.

According to another aspect of the present disclosure, the shearing surface is located on the die assembly and includes a center portion along the axis, a mid portion that circumferentially surrounds the center portion, and an outer rim portion that circumferentially surrounds the mid portion. The at least one aperture is defined along the mid portion and extends through a part of the die assembly. The center portion, or the rim portion or both the center and rim portions are configured to rotate about the axis while the mid portion which defines the at least one aperture remains rotationally stationary.

According to another aspect of the present disclosure, the die assembly includes a porthole extrusion die that is rotationally stationary and defines the at least one aperture. A shearing plate that is configured to rotate about the axis is located axially in front of the porthole extrusion die. The shearing surface is located along the shearing plate.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims. This section provides a general summary of the disclosure and is not to be interpreted as a complete and comprehensive listing of all of the objects, aspects, features and advantages associated with the present disclosure. Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1A is a schematic view of an extrusion system that includes a feedstock rotation mechanism according to one aspect of the present disclosure;

FIG. 1B is a schematic back view of the extrusion system from FIG. 1A;

FIG. 2 is a perspective view of an example die assembly usable with the systems of FIG. 1A and FIG. 1B;

FIG. 3 is a schematic view of an extrusion system that includes a die assembly with spinning sections according to another aspect of the present disclosure;

FIG. 4 is a front view of an example die assembly usable with the system of FIG. 3;

FIG. 5 is a perspective view of a shearing plate in front of an extrusion die according to another aspect of the disclosure;

FIG. 6 is a cross-sectional view of the shearing plate and extrusion die from FIG. 5;

FIG. 7A is a rear perspective view of a shearing plate like that of FIG. 5;

FIG. 7B is a side view of the shearing plate of FIG. 7A;

FIG. 8 is a perspective view of an alternative shearing plate design in front of a die assembly that is usable with the system of FIG. 3;

FIG. 9 is a is a cross-sectional view of the die assembly of FIG. 8;

FIG. 10 is a perspective view of the shearing plate of FIG. 8;

FIG. 11 is a side view of the shearing plate of FIG. 8;

FIG. 12 is a graphical illustration comparing a ram speed to time over a production cycle;

FIG. 13 is a graphical illustration comparing a rotational speed to time over a production cycle; and

FIG. 14 is a flow diagram illustrating a method for extruding a component.

### DESCRIPTION OF THE ENABLING EMBODIMENTS

Example embodiments will now be described more fully with reference to the accompanying drawings. In general, the subject disclosure is directed to an extrusion system including a feedstock and/or shearing surface rotation mechanism for extruding components such as automotive structures, and a method of the same. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms that none should be construed to limit the scope of the disclosure, and that various features of the embodiments are combinable with one another, even if not expressly stated. In some example embodiments, well-known processes, well-known device structures, and well-known technologies are not described in detail.

Referring to the figures, wherein like numerals indicate corresponding parts throughout the views, an extrusion system that includes a feedstock or shearing surface rotation mechanism and method of the same are provided. The invention permits the formation of extruded components, such as automotive components, out of a large range of materials and into various shapes.

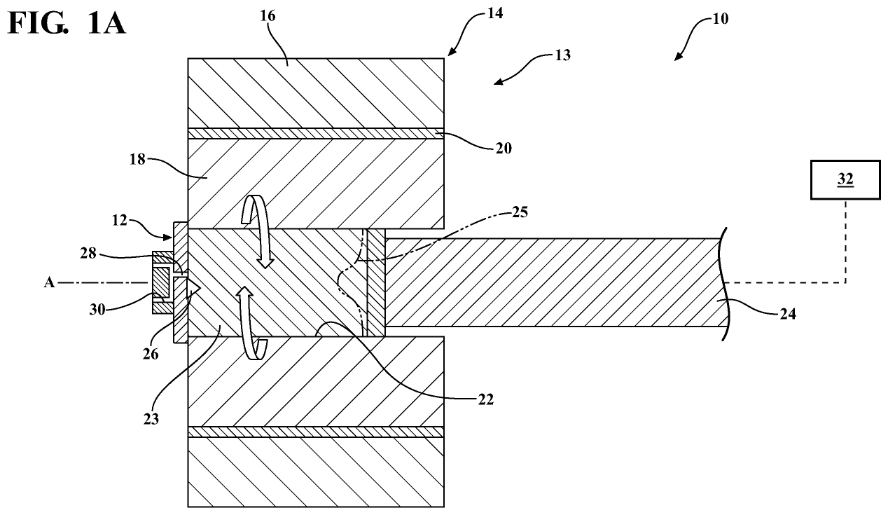

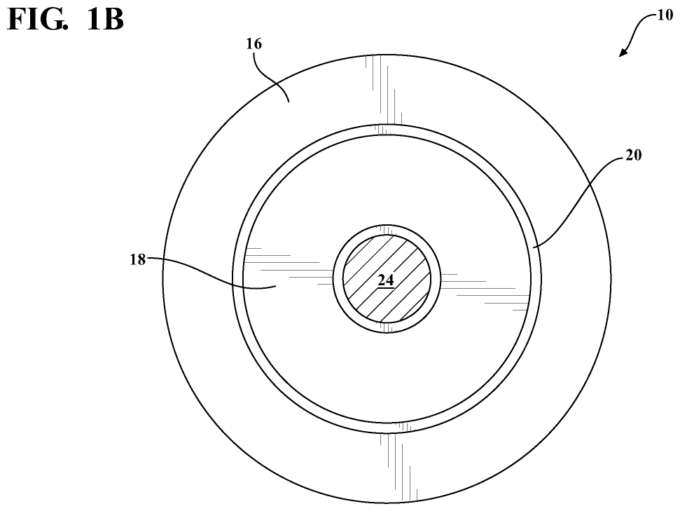

With initial reference to FIGS. 1A-1B, a schematic side view of an extrusion system 10 that includes a die assembly 12 and feedstock assembly 13 is shown. The feedstock assembly 13 includes a container 14 that includes an outer container shell 16 and a drum 18 located and rotatable within the outer container shell 16. A bearing 20 may be located between the outer container shell 16 and the drum 18 to facilitate rotation of the drum 18 around an axis A. The drum 18 defines a channel 22 for holding and rotating feedstock materials to be extruded 23, which is shown in the example arrangements as a billet 23. The terms “feedstock” and “billet” as discussed herein may include various types of materials such as cast billets, chip briquettes or compressed metal powders, and may have various sizes and shapes. The drum 18 may include teeth (not shown) or other structures for holding the billet 23 for co-rotation. Moreover, the billet 23 may include ends with surface topographies (schematically shown in FIG. 1A at 25) that permit rotationally joining with other billets 23 to facilitate co-rotation and continuous feeding. The channel 22 may be cylindrical shaped and is bounded on one end by a ram 24 and another end by the die assembly 12. The die assembly 12 may be rotationally stationary. In operation, the ram 24 moves along the axis A and pushes the billets 23 into the die assembly 12 while the billets 23 are rotated by the container 14. In some embodiments, the ram 24 may be hydraulically actuated. In this embodiment, the die assembly 12 includes a shearing surface 26 (schematically shown) that shears and heats the billets 23 prior to being extruded. The die assembly 12 further includes one or more apertures 28 for permitting the billet 23 to flow therethrough and into an extrusion opening 30 through which the billet 23 is extruded into the desired shape. A control system 32 may dictate operation of the extrusion system 10. The control system 32 may include one or more motors, controllers, and processors that are configured to perform the methods described herein.

In more detail, in use, the drum 18 rotates the billet 23 while the ram 24 pushes the billet 23 into the shearing surface 26 of the die assembly 12 which causes the billet 23 to be heated, sheared, and expelled through the at least one aperture 28 where it is pushed through the extrusion opening 30 and then allowed to cool to create the final part. The extrusion opening 30 may be that of a desired cross-section of the extruded part. It should be appreciated that because the aperture 28 remains rotationally stationary during this process, a uniform flow of the heated and sheared material is provided to the extrusion opening 30, which provides a repeatable extrusion process. In alternative arrangements, the one or more apertures 28 could serve as a final extrusion opening for the material. This could be applied for all discussed arrangements.

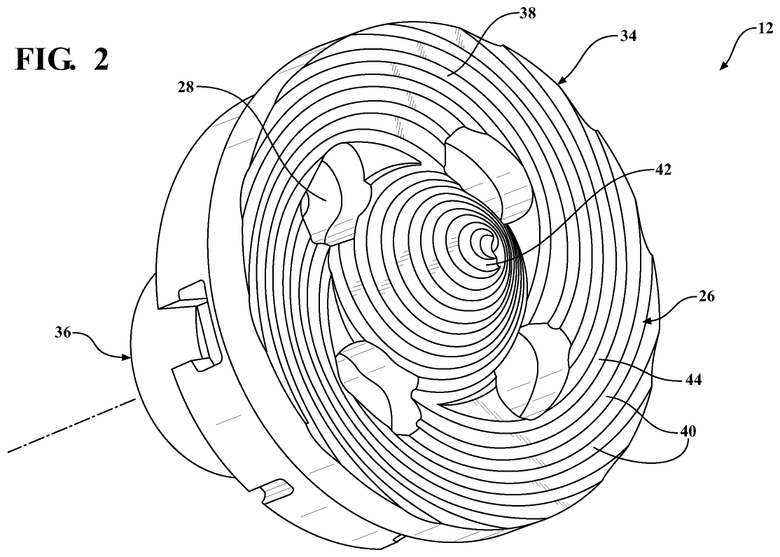

FIG. 2 is a perspective view of an example die assembly 12 that may be used with the system of FIG. 1A. The die assembly 12 includes a head 34 and a body 36. The body 36 extends along the axis A to the head 34, which extends radially outwardly from the body 36. The head 34 includes a shearing face 38 opposite the body 36 that defines the shearing surface 26. The shearing surface 26 could have any number of configurations and surface topographies. The shearing surface 26 may be part of the body 36 and/or, as will be discussed later, may be configured on a plate that is located in front of the body 36 region. The shearing surface 26 may include a plurality of grooves 40 for shearing and or otherwise heating and disrupting the feedstock. The plurality of grooves 40 may be spiral shaped and substantially circumferentially symmetric with respect to the axis A. The head 34 may include a conical-shaped center portion 42 extending along the axis A that is surrounded by an outer portion 44 that is concaved towards the center portion 42. These features facilitate the flow of the sheared billet 23 toward and through the one or more apertures 28, after which it flows through the extrusion opening 30. In some embodiments, as illustrated in FIG. 2, the at least one aperture 28 may include a plurality of apertures circumferentially arrayed about the axis A and disposed in the outer portion 44. In some embodiments, each of the apertures 28 may be equal in size and shape. In some embodiments, the apertures 28 may be oblong, presenting a larger boarder on a radially most outwardly edge than a boarder of a radially most inwardly edge.

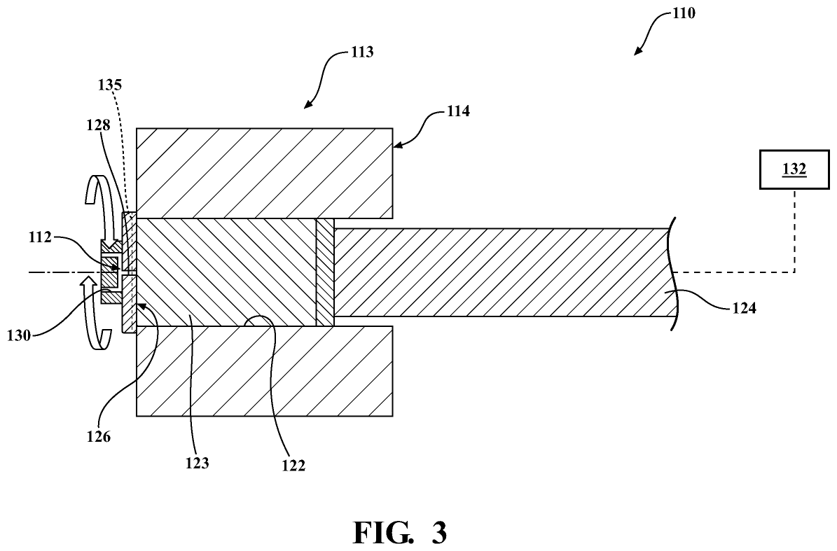

FIG. 3 is a schematic view of an extrusion system 110 according to another aspect of the present disclosure. Unless otherwise indicated, the extrusion system 110 may share all of the same features, properties, and associated processes as the system illustrated in FIGS. 1A and 1B. However, in the present embodiment, the extrusion system 110 may include a die assembly 112 that is configured to partially rotate while the feedstock assembly 113 may be configured to keep the feedstock material 123 rotationally stationary or configured to rotate the feedstock material 123 in a direction opposite the rotation of the die assembly 113. More particularly, the extrusion system 110 may include a container 114 that defines a channel 122 for holding a billet 123. The channel 122 may be cylindrically shaped and bounded on one end by a ram 124, and on another end by the die assembly 112. Therefore, in operation, the ram 124 moves along the axis A and pushes the feedstock into the partially rotating die assembly 112.

In some embodiments, the container 114 is arranged similar to the embodiment presented in FIGS. 1A and 1B, wherein the billet 123 is rotated in a drum (not shown) in a direction opposite to and/or at a different speed than the die assembly 112. The billet 123 may be up to 12″ in diameter and may be rotated at up to 200 rpms. However, in some embodiments, the container 114 may be configured to hold the feedstock such that it does not rotate. Again, a control system 132 may dictate operation of the extrusion system 110. The control system 132 may include one or more motors, controllers, and processors that are configured to perform the methods described herein.

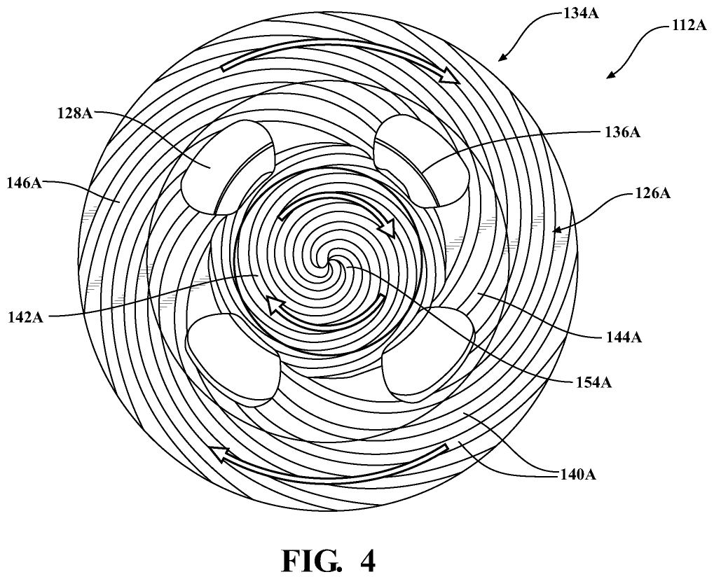

FIG. 4 is a front view of a die assembly 112A that may be used with the system of FIG. 3. The die assembly 112A includes a shearing surface 126A that shears and heats the feedstock 123. The die assembly 112A further includes at least one aperture 128A for permitting the material to flow therethrough and into an extrusion opening 130. Unless otherwise indicated, the die assemble 112A may share all of the same features, properties, and associated processes as those described in relation to other embodiments disclosed herein.

The die assembly 112A includes a head 134A and a body 136A. The body 136A extends along the axis A to the head 134A, which extends radially outwardly from the body 136A. The head 134A defines the shearing surface 126A opposite the body 136A. The shearing surface 126A could have any number of configurations and surface topographies. For example, the shearing surface 126A may include a plurality of grooves 140A. The plurality of grooves 140A may be spiral shaped and substantially circumferentially symmetric with respect to the axis A. The head 134A may include a center portion 142A extending along the axis A that is surrounded by a mid-portion 144A that extends about the axis A, and the mid-portion 144A may be surrounded by an outer rim portion 146A that extends about the axis A. The center portion 142A, the outer rim portion 146A, or both are configured to rotate while the mid-portion 144A remains stationary. The mid portion 144A defines one or more apertures 128A, thus the apertures 128A do not rotate. The center portion 142A and the outer rim portion 146A may be configured to rotate in the same or different directions and at the same or different speeds. The center portion 142A may extend to an apex 154A. It should be appreciated that the stationary arrangement of the mid-portion 144A and the apertures 128A defined therein paired with the rotating center portion 142A and outer rim portion 146A allow the head 134A arrangement to shear the feedstock material first and then pass the material through the apertures 128A to be extruded in any shape through the extrusion openings 130. This arrangement also allows the billet 123 and final extruded products to remain stationary while the rotation of the center and outer rim portions 142A, 146A shear and heat up the billet 123 material.

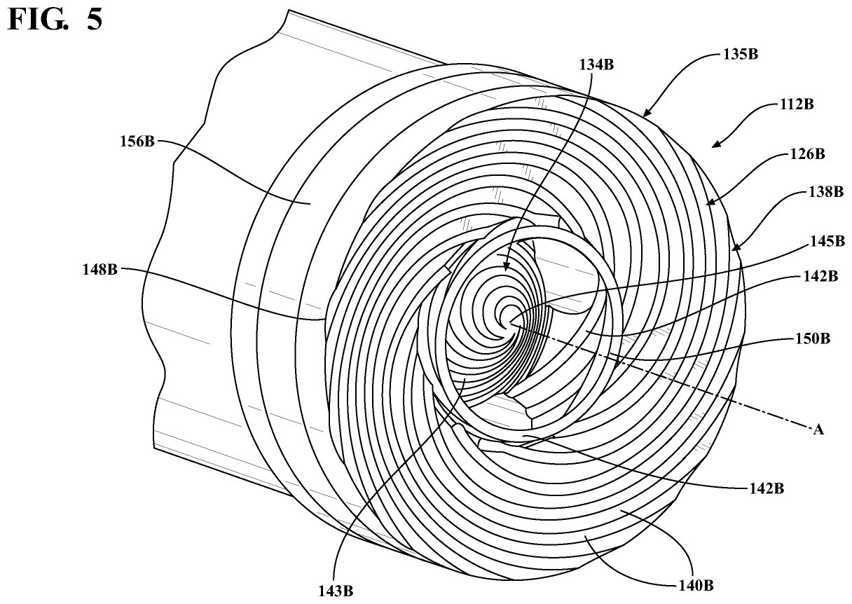

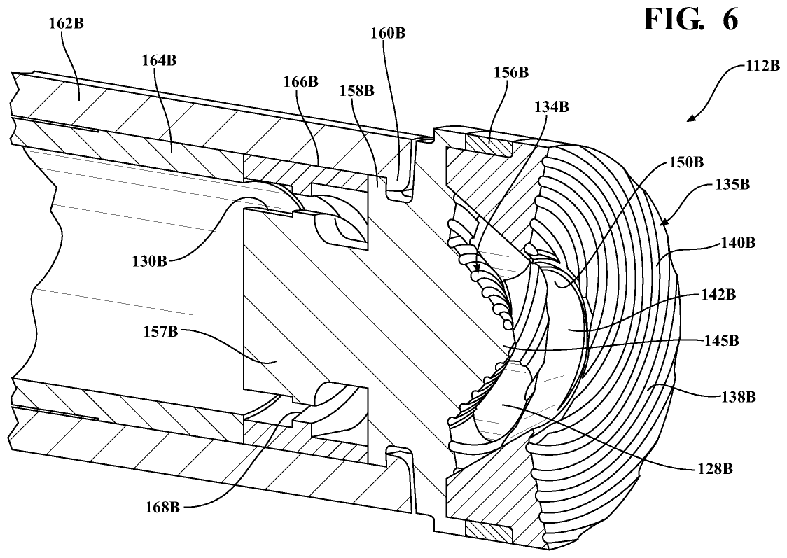

FIG. 5 is a perspective view of another die assembly 112B and a shearing plate 135B that may be used with the system of FIG. 3. Under this arrangement, the die assembly 112B includes a porthole extrusion die 134B. A shearing plate 135B is positioned axially in front of the porthole extrusion die 134B. Unless otherwise indicated, the die assemble 112B may share all of the same features, properties, and associated processes as those described in relation to other embodiments disclosed herein. In more detail, the shearing plate 135B is rotatable about axis A while the porthole extrusion die 134B which includes the one or more apertures 128B remains rotationally stationary. The shearing plate 135B includes a shearing surface 126B that shears and heats the material. The shearing plate 135B further includes at least one shear plate opening 142B for permitting the material to flow therethrough and toward the extrusion porthole die 134B and through the one or more rotationally stationary apertures. In some embodiments, the shearing plate 135B is connected to the porthole extrusion die 134B with a thrust bearing 156B (shown in FIG. 6) to separate the rotational movement of the shearing plate from the porthole extrusion die 134B.

In some embodiments, both the porthole extrusion die 134B and feedstock assembly 113 may be configured to be stationary. More particularly, the extrusion system 110 may include a container 114 that defines a channel 122 for holding a billet 123. The channel 122 may be cylindrically shaped and bounded on one end by a ram 124 and another end by the shearing plate 135B. Therefore, in operation, the ram 124 moves along the axis A and pushes the material toward the shearing plate 135B. The rotation of the shearing plate 135B shears and heats the feedstock materials 123. The sheared materials pass through the shear plate opening 142B to be extruded in the porthole extrusion die 134B. In some embodiments, the container 114 may be configured to hold the material to be extruded such that it does not rotate. Alternatively, the container 114 may be configured to rotate the feedstock materials 123 in a direction opposite that of the shearing plate 135B and/or at a different speed than the shearing plate 135B.

The shearing surface 126B could have any number of configurations and surface topographies. For example, the shearing surface 126B may include a plurality of grooves 140B. The plurality of grooves 140B may be spiral shaped and substantially circumferentially symmetric with respect to the axis A. The shearing plate 135B may include an outer edge 148B and an inner edge 150B and the central opening 142B. The shearing plate 135B is angled or concaved in a direction towards the shear plate opening 142B from the outer edge 148B to the inner edge 150B. The thrust bearing 156B may be connected to the shearing plate 135B and permit it to rotate with respect to the porthole die 134B. Thus in some embodiments, the shearing plate 135B rotates and the porthole die 134B remains stationary. As best shown in FIG. 6, the porthole die 134B may include a face 143B that includes a central portion 145B that is conically shaped. The face 143B of the porthole extrusion die 134B may include additional grooves. This arrangement also allows the billet 123 to remain stationary due to the rotation of the outer shearing plate 135B.

FIG. 6 is a cross-sectional view of the die assembly 112B from FIG. 5. In some embodiments, the porthole die 134B may include a tail 157B with an annular flange 158B for accommodating an inwardly extending ring 160B of the body on one side thereof. The die assembly 112B also includes an outer sleeve 162B, an inner sleeve 164B, and an insert 166B. The opening between the tail 157B and insert 166B may define the extrusion opening 130B.

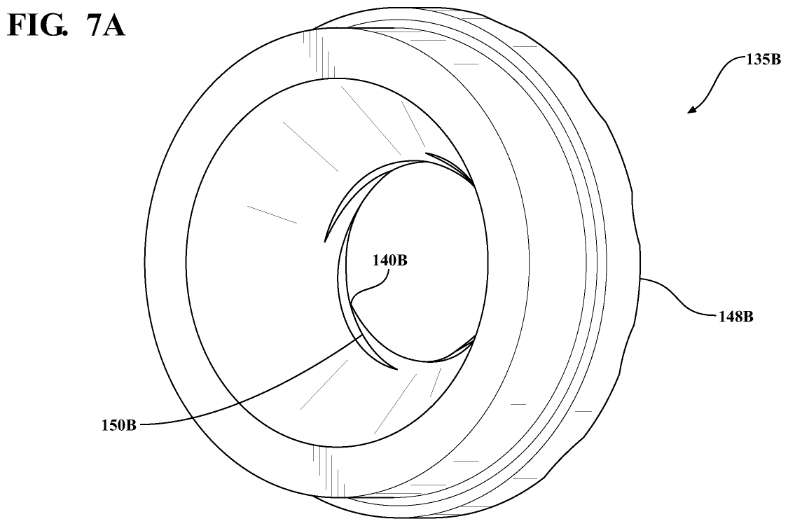

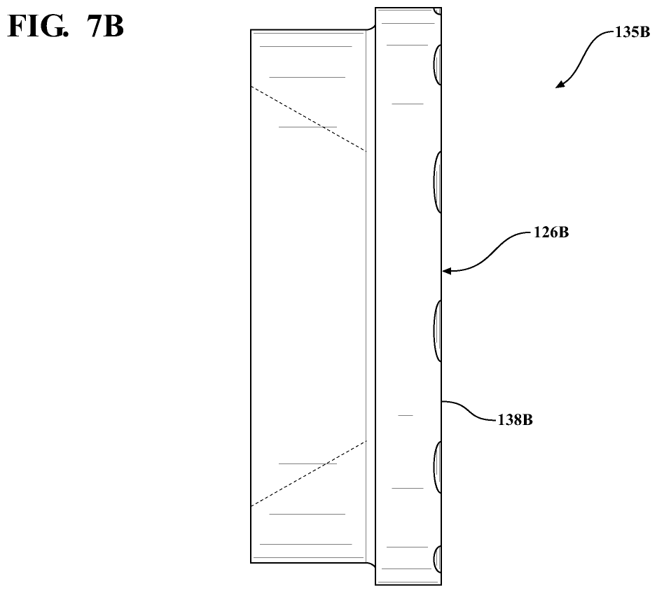

FIG. 7A is a rear perspective view of the shearing plate 135B of the die assembly 112B from FIG. 5. The plurality of grooves 140B may extend from the inner edge 150B to the outer edge 148B. FIG. 7B is a side view of the shearing plate 135B. The shearing plate 135B defines a surface opposite the shearing face 138B that is conically shaped.

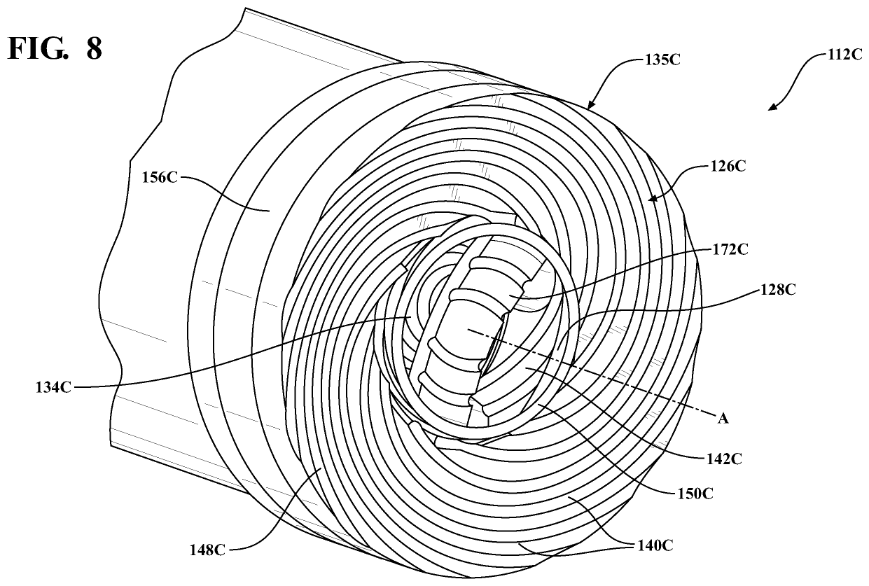

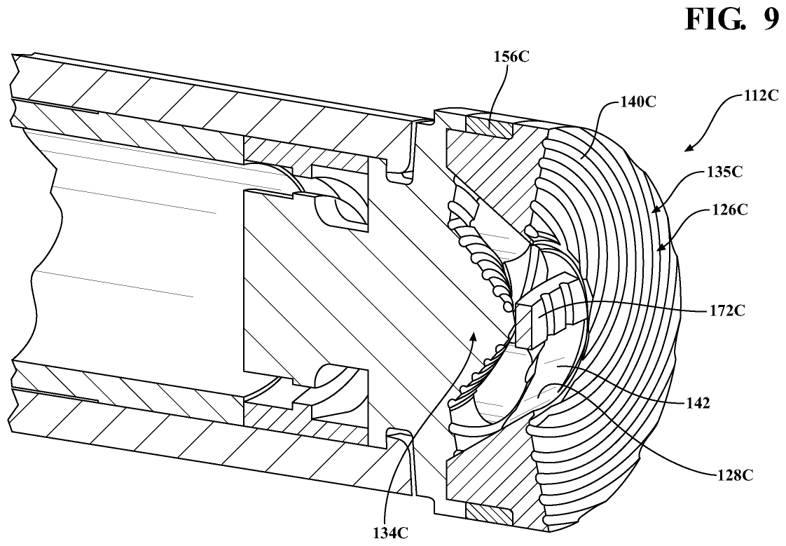

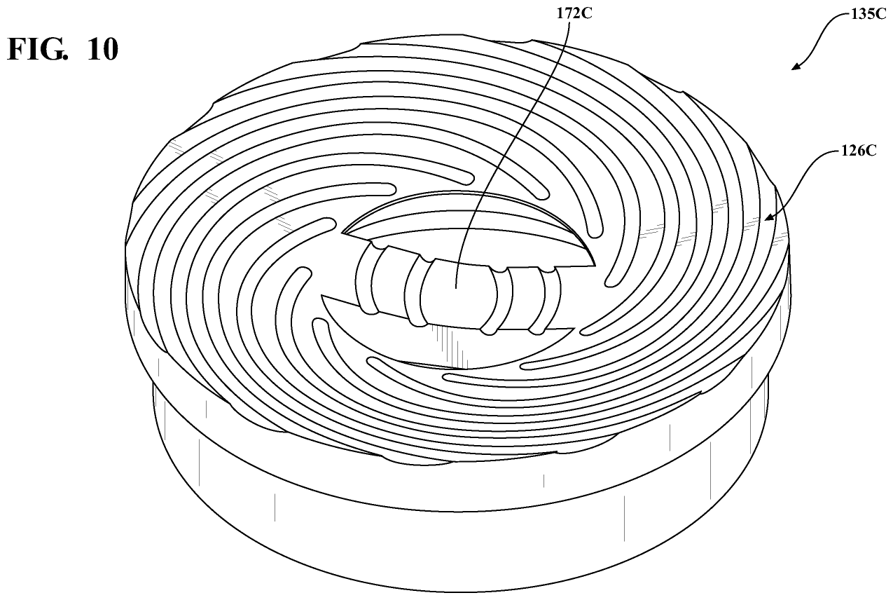

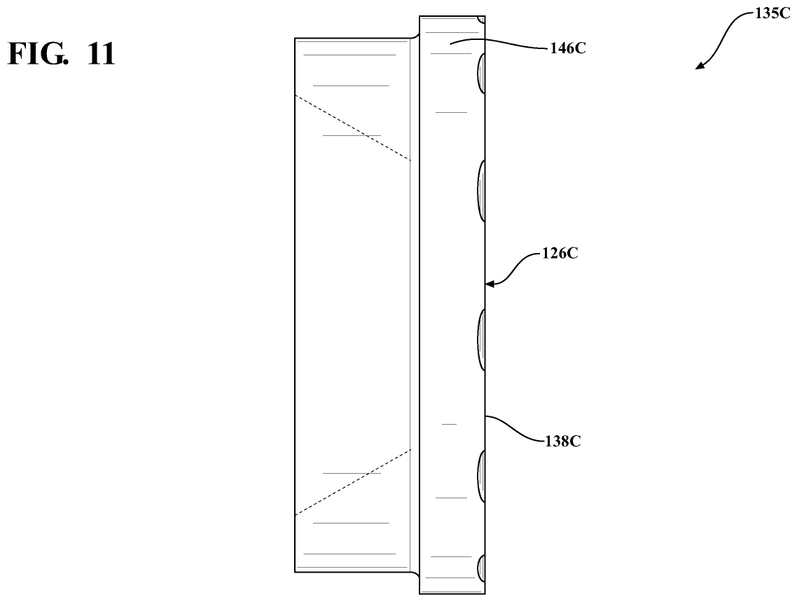

FIG. 8 is a perspective view of another example die assembly 112C that may be used with the system of FIG. 3. Like the arrangement of FIGS. 5-7B, the die assembly 112C includes a shearing plate 135C in front of porthole extrusion die 124C. The shearing plate 135C includes a shearing surface 126C that shears and heats the material. The shearing plate 135C further includes at least one shearing plate opening 142C for permitting the material to flow therethrough and toward the porthole extrusion die 134C and through the one or more apertures 128C. Unless otherwise indicated, the die assemble 112C may share all of the same features, properties, and associated processes as those described in relation to other embodiments disclosed herein. In some embodiments, the die assembly 112C may share all the properties with the die assembly 112B illustrated in FIGS. 5 through 7B. The shearing plate 135C further includes a shearing band 172C that extends across the inner edge 150C of the shearing plate 135C. In some embodiments, the shearing band 172C defines portions of the plurality of grooves 140C. FIG. 9 is a is a cross-sectional view of the shearing plate 135B from FIG. 8 illustrating the thrust bearing 156C and additional features of the die assembly 112C, which is similar and includes the same features illustrated in FIG. 6 as it relates to the previous embodiment. FIG. 10 is a perspective view of the shearing plate 135C. As illustrated, the shearing plate 135C and the shearing band 172C together define a shearing face 138C that is concave. The addition of the shearing band 172C makes it possible to shear the center of the feedstock materials during the shearing extrusion process. FIG. 11 is a side view of the shearing plate 135C.

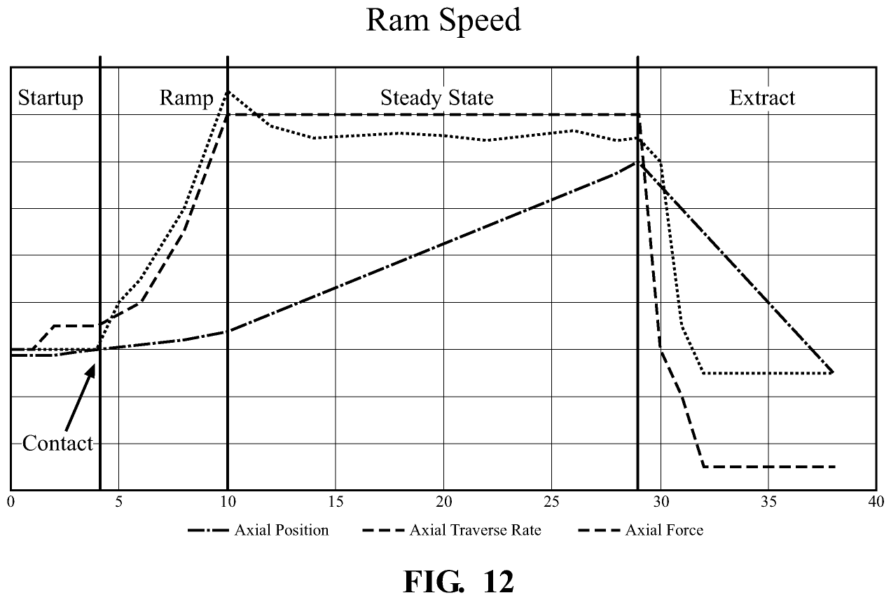

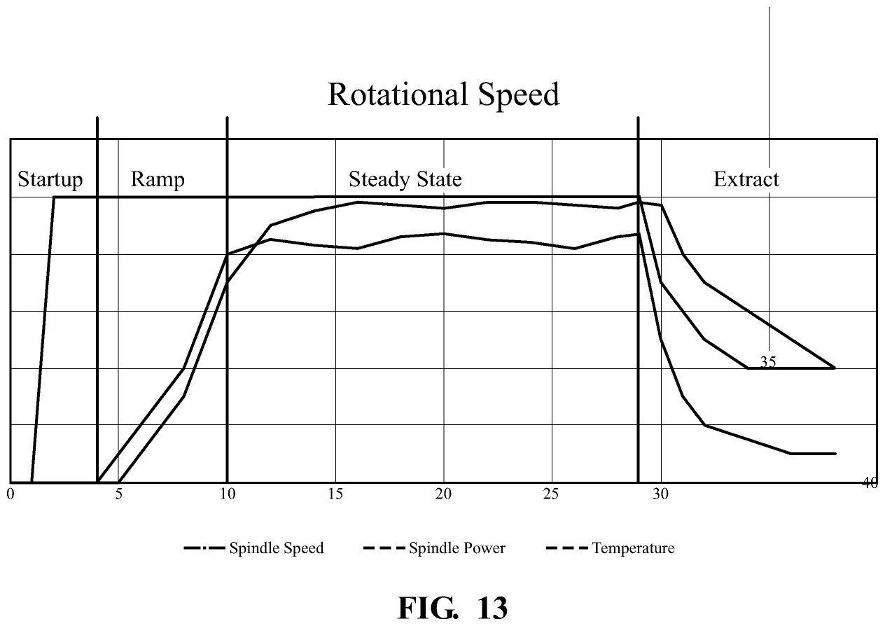

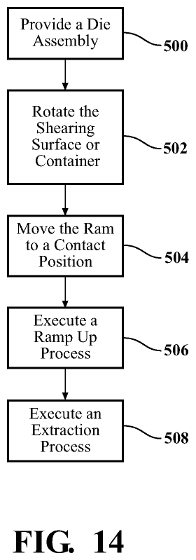

In accordance with some embodiments, a method of extruding a material with the extrusion system is provided and presented in FIG. 14. The method may include the step of 500 providing a die assembly 12, 112 in axial alignment with a channel 22, 122 of a container 14, 114. The method may also include an initial start-up process. To initiate the process, the method includes 502 rotating at least part of the shearing surface 26, 126 or the container 14, 114 about the axis A, with at least one of the apertures 28, 128 remaining rotationally stationary. Once up to a predetermined speed (e.g., 200 rpms), the method includes 504 slowly moving the ram 24, 124 from a defined pre-extrusion position to a contact position. The contact position is defined as the point at which the shearing surface 26, 126 of the shearing plate 135B, 135C contacts the billet 23, 123. The method may then include 506 executing a ramp-up process. In the ramp-up process, once contact position is reached, the axial velocity of the ram 24, 124 is slowly increased. This results in rapid increases in force, power, and temperature. The example timing chart in FIGS. 12 and 13 show the peak force at around 10 seconds, which may reflect the highest force exerted during any particular processing condition. The point at which maximum force is required will depend on several factors and parameters. After the ramp up is complete, the process is continued in a steady state. In the above example, the rotation and axial velocity are kept constant, resulting in temperature and axial forces that vary slightly. Alternatively, speeds could be varied to maintain a set temperature, and axial velocity varied to maintain a set axial force. Next, the method includes 508 executing an extraction process. During this process, the ram 24, 124 velocity is quickly reduced to zero, and then the axis direction is reversed. The spindle speed is lowered during the initial steps of the extraction but not stopped altogether to avoid adherence of the feedstock and the tooling. Once the ram 24, 124 is clear of the feedstock, both the axial and rotational motion is halted. The cycle is complete when motion is confirmed to be halted.

In accordance with the above, all arrangements of the subject system allow the material of the feedstock 23, 123 to remain rotationally stationary while being pushed through the aperture 28, 128 after having been sheared and heated via rotation of the shearing surface 26, 126 or feedstock 23, 123 (via the container 14, 114). Shearing and heating the feedstock material 23, 123 prior to entering the aperture 28, 128 effectively softens the material for extrusion. The rotationally stationary arrangement of the aperture 28, 128 provides a uniform flow of the material through the aperture 28, 128, and toward an extrusion opening 30, 130. This allows products of various shapes to repeatably be extruded through the extrusion opening 30, 130 without rotation of the final extruded products. This also allows different feedstock materials 23, 123 such as casting billets or chip briquettes of various alloys to be extruded.

It should be appreciated that the foregoing description of the embodiments has been provided for purposes of illustration. In other words, the subject disclosure it is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

1. An extrusion system comprising:
a container defining a channel extending along an axis for holding a feedstock;
a ram located on a first axial side of the channel and a die assembly located on a second axial side of the channel opposite the first axial side;
the die assembly defining at least one aperture extending through a part of the die assembly;
the ram axially movable to push the feedstock into the die assembly to extrude the feedstock through the at least one aperture; and
a shearing surface configured to shear and heat the feedstock prior to entering the at least one aperture;
wherein at least part of the shearing surface or the container are configured to rotate about the axis while the at least one aperture remains rotationally stationary.

2. The extrusion system of claim 1, wherein at least part of the container is configured to rotate with the feedstock, and wherein the shearing surface and the die assembly are rotationally fixed.

3. The extrusion system of claim 2, wherein the container includes an outer container shell and a drum located in the outer container shell and defining the channel, and wherein the drum is rotatable about the axis relative to the outer container shell and is configured to rotate the feedstock.

4. The extrusion system of claim 1, wherein the shearing surface is part of the die assembly and includes a center portion along the axis, a mid portion that circumferentially surrounds the center portion, and an outer rim portion that circumferentially surrounds the mid portion, wherein the at least one aperture is defined along the mid portion and extends through a part of the die assembly, and wherein the center portion, or the rim portion or both the center and rim portions are configured to rotate about the axis while the mid portion which defines the at least one aperture remains rotationally stationary.

5. The extrusion system of claim 1, wherein the die assembly includes a porthole extrusion die being rotationally stationary and defining the at least one aperture, wherein a shearing plate is located axially in front of the porthole extrusion die opposite the ram and configured to rotate about the axis, and wherein the shearing surface is located along the shearing plate.

6. The extrusion assembly of claim 5, further including a thrust bearing located between the shearing plate and the porthole extrusion die and configured to accommodate rotation of the shearing plate relative to the porthole extrusion die.

7. The extrusion assembly of claim 5, wherein the porthole extrusion die includes a conical shaped portion, and wherein the shearing surface is further located along the conical shaped portion of the porthole extrusion die.

8. The extrusion assembly of claim 7, wherein the shearing plate defines a central hole along the axis in axial alignment with the conical shaped portion of the porthole extrusion die.

9. The extrusion assembly of claim 7, wherein the shearing plate tapers radially inwardly as it extends axially away from the ram such that the shearing surface along the shearing plate is oriented toward the channel of the container.

10. The extrusion assembly of claim 8, wherein a shearing band extends across the central hole of the shearing plate, and wherein the shearing surface is further located along the shearing band.

11. The extrusion assembly of claim 1, wherein the shearing surface defines a plurality of grooves for shearing and heating the feedstock.

12. The extrusion system of claim 11, wherein the plurality of grooves are spiral shaped.

13. A method for extruding materials, comprising:
providing a container defining a channel extending along an axis for holding a feedstock;
providing a die assembly in axial alignment with the channel of the container, the die assembly defining at least one aperture extending through part of the die assembly;
pushing the feedstock against the die assembly to push the material through the at least one aperture;
providing a shearing surface for shearing and heating the material prior to entering the at least one aperture; and
rotating at least part of the shearing surface or the container about the axis with the at least one aperture remaining rotationally stationary.

14. The method of claim 13, wherein rotating at least part of the shearing surface or the container includes rotating at least part of the container to rotate the feedstock, and wherein the shearing surface and the die assembly remain stationary.

15. The method of claim 13, wherein the shearing surface is located on the die assembly and includes a center portion along the axis, a mid portion that circumferentially surrounds the center portion, and an outer rim portion that circumferentially surrounds the mid portion, wherein the at least one aperture is defined along the mid portion and extends through a part of the die assembly, and wherein rotating at least part of the shearing surface or the container includes rotating the center portion, the rim portion or both the center and rim portions while the mid portion remains rotationally stationary.

16. The method of claim 13, wherein the die assembly includes a porthole extrusion die being rotatably stationary and defining the at least one aperture, wherein a shearing plate is located axially in front of the porthole extrusion die opposite the ram, wherein the shearing surface is located on the shearing plate, and wherein rotating at least part of the shearing surface or the container includes rotating the shearing plate while the porthole extrusion die remains rotationally stationary.

17. The method of claim 16, wherein a thrust bearing is located between the shearing plate and the porthole extrusion die and is configured to accommodate rotation of the shearing plate relative to the porthole extrusion die.

18. The method of claim 16, wherein the porthole extrusion die includes a conical shaped portion, and wherein the shearing surface is further located along the conical shaped portion of the porthole extrusion die.

19. The method of claim 18, wherein the shearing plate defines a central hole along the axis in axial alignment with the conical shaped portion of the porthole extrusion die

20. The method of claim 19, wherein the shearing plate tapers radially inwardly as it extends axially away from the ram such that the shearing surface along the shearing plate is oriented toward the channel of the container
